(19) United States
(12) Patent Application Publication
(10) Pub. No.: US 2024/0046229 A1
(43) Pub. Date: Feb. 8, 2024

(54) AN OPERATING COMPUTER FOR PAYMENT SETTLEMENT, PAYMENT SETTLEMENT SYSTEM, AND PAYMENT SETTLEMENT METHOD

(71) Applicant: Seong Min YOON, Guri-si (KR)

(72) Inventor: Seong Min YOON, Guri-si (KR)

(21) Appl. No.: 18/268,325

(22) PCT Filed: Dec. 17, 2021
(86) PCT No.: PCT/KR2021/019296

§ 371 Date: Jun. 20, 2023

(30) Foreign Application Priority Data
Dec. 21, 2020 (KR) 10-2020-0179711

(51) Int. Cl. G06Q 20/10; G06Q 20/42; G06Q 20/38

(52) U.S. Cl. CPC G06Q 20/10; G06Q 20/42; G06Q 20/381

(57) ABSTRACT

An operating computer for managing payment settlement including at least one hardware processor and a memory storing a payment settlement-related computer program or web program is provided, wherein the at least one hardware processor controls the execution of the computer program or web program stored in the memory to: receive information of a request for payment settlement of a transaction amount via a virtual account of a buyer and a virtual account of a supplier; receive payment settlement approval information provided by a non-related person terminal used by at least one non-related person unrelated to the buyer and the supplier extracted from the communication details of the buyer and the supplier; and process the transfer of the transaction amount from the buyer virtual account to the supplier virtual account based on the payment settlement approval information of the non-related person.

### BACKGROUND OF THE INVENTION

### Field of the Invention

The present invention relates to an operating computer for a payment settlement, a payment settlement system, and a payment settlement method. More specifically, it is possible to trade goods such as products and services between people, companies, or organizations connected to a communication network such as the Internet anywhere in the world, and to make instant payments online. Furthermore, the present invention also relates to a payment settlement operating computer, a payment settlement system, and a payment settlement method that brokers and manages real-time payment between buyers and suppliers in any asset, including commercially available currency, cryptocurrency, physical-based assets, and other value-added virtual assets, whose exchange rate is determined online, a payment system, and a payment method.

### Description of Related Art

In the settlement of payments based on the transaction of goods between a buyer and a supplier, In particular, payment settlement between countries with different types of currencies is usually settled by converting the currency at the exchange rate of the relevant currency. However, the foreign exchange method of payment settlement causes inconvenience and financial losses due to excessive exchange fees. In addition, there are many cases where it is not possible to settle payments between parties with different types of assets.

As an invention to solve the problems of payment settlement through conventional foreign exchange conversion, the invention of a foreign exchange conversion brokerage service method via the Internet of Korean Publication Patent No. 10-2001-0110071 (publication date: Dec. 12, 2001) is disclosed.

The disclosed invention includes a procedure for creating a customer account to record a customer's foreign exchange reserves and notifying the customer account number to the customer's terminal; a procedure for posting transaction request information upon receiving it from the customer's terminal; a procedure for examining whether any of the transaction requests already posted satisfy the conditions for concluding a transaction; a procedure for concluding a transaction between two customers if any of the transaction requests satisfy the conditions for concluding a transaction; and a procedure for performing an actual transfer of the transaction amount through the bank accounts of the concluded customers and reflecting the transaction details in the customer accounts.

The disclosed invention has the convenience of allowing users to convert foreign currencies online, but it has the problem that foreign exchange transactions are limited to currencies circulating in the market and cannot be carried out with various types of assets between the transaction parties, and the problem of authentication of the identity for online currency exchange and authorization of currency exchange, etc.

Therefore, there is a need for an invention for online payment settlement that can be made with any kind of assets as well as payment settlement between different currencies circulating in the market, and can be made safely, reliably, and in real-time through objective authentication and security of transaction details in payment settlement.

### SUMMARY OF THE INVENTION

The present invention is to solve the problems of the prior art. An object of the present invention is to provide a payment settlement operating computer and a payment settlement method in which payment settlement between transaction parties can be made in real-time through online without the help of a third party such as an intermediary organization, regardless of the country, region, type of currency, and type of asset to be paid or received.

Another object of the present invention is to provide a payment settlement operating computer, a payment settlement system, and a payment settlement method that enhances the security of transactions by providing a separate identification information to a transaction party that is distinct from the identification of the transaction party, and by distributively storing and processing the elements necessary for accessing the identification information in the system and the transaction party's terminal.

Another objective of the present invention is to provide a payment settlement operating computer, a payment settlement system, and a payment settlement method that can secure the objectivity of payment settlement by authorizing the payment settlement details of a purchaser by non-related persons not related to the purchaser when performing payment settlement between transaction parties.

Another objective of the present invention is to provide a payment settlement operating computer, a payment settlement system, and a payment settlement method that enhances the security of payment settlements based on transactions by transmitting and receiving confirmation messages by the non-related person of the transaction parties when performing payment settlements based on transactions between the transaction parties.

A technical solution to achieve the object of the present invention, in a first aspect of the present invention, an operating computer for managing a payment settlement in a transaction between a buyer and a supplier comprising: at least one processor and a memory coupled to the processor that causes the computer to perform: receiving a payment settlement request for a transaction for goods with a supplier using a buyer virtual account; analyzing the communication history of the buyer and the supplier to extract the related person information of the buyer and the supplier, and selects a non-related person of the buyer and the supplier who excludes the extracted related person information as an approval participant for the buyer's payment settlement request; receiving an approval information of payment settlement for the buyer's transaction via the selected non-related terminal of the non-related person; querying the exchange reference rate information to be applied if the type of payable asset in the buyer virtual account is different from the type of receivable asset in the supplier virtual account, and subtracting the payable asset of the transaction from the buyer virtual account and increasing the receivable asset of the transaction using the exchange rate queried in the supplier virtual account.

In a second aspect of the present invention, there is provided a payment settlement method including an operating computer for the payment settlement described in the first aspect of the present invention.

Further, in a third aspect of the present invention, comprising: receiving, by an operating computer, a payment settlement request for a transaction for goods with a supplier using a buyer virtual account; analyzing, by the operating computer, the communication details of the buyer and the supplier to extract the related person information of the buyer and the supplier, and selects a non-related person of the buyer and the supplier who excludes the extracted related person information as an approval participant for the buyer's payment settlement request; receiving, by the operating computer, an approval information of payment settlement for the buyer's transaction via the selected non-related terminal of the non-related person; querying, by the operating computer, the exchange reference rate information to be applied if the type of payable asset in the buyer virtual account is different from the type of receivable asset in the supplier virtual account, and subtracting the payable asset of the transaction from the buyer virtual account and increasing the receivable asset of the transaction using the exchange rate queried in the supplier virtual account.

### Advantageous Effects

According to the present invention, payment settlements between transaction parties can be made online in real-time regardless of country, region, type of currency, and type of asset to be paid or received, the security of the transaction can be enhanced by granting a separate identification information to the transaction party that is distinct from the identification of the transaction party and distributively storing and processing the elements necessary to access the identification information in the system and the transaction party's terminal, etc., improved objectivity of the payment settlement can be achieved by authorizing the payment details of the buyer through the approval of non-related persons who are not related to the buyer when performing the payment settlement between the transaction parties, and the security of payment settlements based on transactions can be enhanced by sending and receiving confirmation messages by non-related persons of the transaction parties when performing payment settlements based on transactions between the transaction parties.

In addition, it is possible to reduce many fees (such as remittance fees, currency conversion fees, intermediary bank fees, SWIFT fees, etc.) paid to intermediaries in existing cross-asset transactions and eliminate or shorten the waiting time for payment settlement.

### BRIEF DESCRIPTION OF THE DRAWINGS

FIG. 1 is a schematic configuration diagram of an embodiment of a payment settlement system of the present invention.

FIG. 2 is a schematic configuration diagram of an embodiment of an operating computer, which is a main part of the payment settlement system of the present invention.

FIG. 3 is a schematic configuration diagram of an embodiment of a virtual account information management module, which is a main part of the operating computer of the present invention.

FIG. 4 is a schematic configuration diagram of an embodiment of a transaction information management module, which is a main part of the operating computer of the present invention.

FIG. 5 is a schematic configuration diagram of an embodiment of a data storage device, which is a main part of the payment settlement system of the present invention.

FIG. 6 is a schematic configuration diagram of an embodiment of a buyer's terminal, which is a main part of the payment settlement system of the present invention.

FIG. 7 is a schematic configuration diagram of an embodiment of a payment settlement information management module, which is a main part of the buyer's terminal of the present invention.

FIG. 8 is a schematic configuration diagram of an embodiment of a virtual account information management module, which is a main part of the purchasing terminal of the present invention.

FIG. 9 is a schematic configuration diagram of an embodiment of a buyer non-related person terminal, which is a main part of the payment settlement system of the present invention.

FIG. 10 is a schematic configuration diagram of an embodiment of a non-related person information management system, which is a main part of the payment settlement system of the present invention.

FIG. 11 is a flow chart to illustrate an embodiment of the payment settlement method of the present invention.

### DETAILED DESCRIPTION OF THE PREFERRED EMBODIMENTS

Hereinafter, embodiments of the present invention will be described in detail with reference to the accompanying drawings.

Terms used in the description of the embodiments of the present invention will be defined. The various computers and terminals used in the present invention may be configured with hardware itself, or may be configured with computer programs and web programs that utilize the hardware resources. For example, an operating computer of the present invention may consist of each configuration of hardware included in such a computer, and each component of a web program or computer program stored in a storage medium of such a computer may be executed by utilizing hardware resources (at least one processor) of a central processing unit (CPU), including instructions and algorithms stored in registers of the computer.

Further, as used or may be used in the description of embodiments of the present invention, the terms ˜computing device and ˜system may comprise configurations that include at least one computer and that computer includes a hardware processor and a memory storing an operative program.

In addition, the terms “part,” “module,” “means,” or “unit” as used or may be used in the description of exemplary embodiments of the present invention are terms that may be used interchangeably for the same configuration, and may be used interchangeably as appropriate for the action of the component in question. The terms may refer to hardware configurations of computers or terminals, and may refer to respective components of web programs or computer programs stored on storage means of computers and terminals and executed under the control of a central processing unit (CPU) or processor.

In embodiments of the present invention, the above terms are primarily used to refer to each component of the web program or computer program.

Any other terms or expressions not defined herein are not intended to be limited to such terms or expressions, and may have a greater meaning in the action or function of the component they represent.

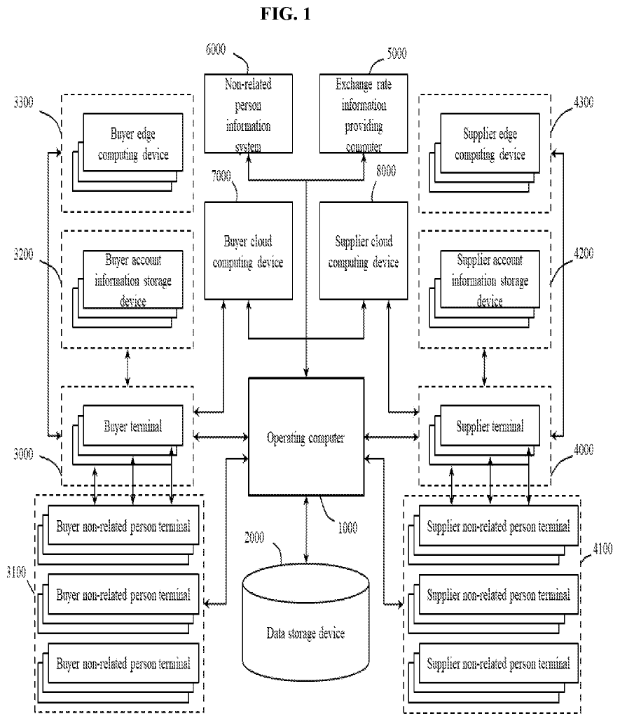

FIG. 1 is a schematic configuration diagram of an embodiment of a payment settlement system of the present invention.

As illustrated in FIG. 1, the payment settlement system of the present invention comprises: an operating computer 1000 that manages information of transaction parties including a buyer and a supplier, manages a purchase and sale exchange rate between assets that is updated in real time when the types of payment settlement assets between the transaction parties are different, and manages online payment settlement of transactions in real time; a data storage device 2000 that is in communication with the operating computer 1000 or is included in the operating computer 1000 and stores and manages data such as member information, virtual account information of members, purchase and sale exchange rate, and transaction information; at least one buyer terminal 3000 used by a buyer who wishes to purchase goods and make payment; at least one buyer non-related terminal 3100 used by non-related persons related to the buyer using the buyer terminal 3000; and a buyer account information storage device 3200 storing account information opened at a commercial bank of the buyer; a buyer edge computing device 3300, including storage devices of the buyer terminal 3000, storage devices associated with the buyer terminal 3000, or external storage devices used by buyers other than the buyer terminal 3000; at least one supplier terminal 4000 used by a supplier who supplies goods and receives assets for payment; and at least one supplier non-related person terminal 4100 used by non-related persons associated with the supplier using the supplier terminal 4000; a supplier account information storage device 4200 storing account information held at a commercial bank of the supplier; and a supplier edge computing device 4300 including storage means of the supplier terminal 4000, storage means associated with the supplier terminal 4000, or external storage means used by a supplier other than the supplier terminal 4000; an exchange rate information provision computer 5000 communicatively connected to the operating computer 1000 to provide exchange rate information between currencies of various countries in the market or exchange rate information between assets in real-time to the above operating computer 1000 (hereinafter, “exchange rate information between currencies or trading reference rate information between assets” will be referred to as “exchange rate information” for simplicity, accordingly, the term “exchange rate information” is defined as a concept indicating an exchange rate between currencies of different types or encompassing an exchange rate between assets of different types); an exchange rate information provision computer 5000 communicatively connected to the above operating computer 1000, which extracts related persons when authenticating the identities of a buyer and a supplier requesting membership and supports the identification of the membership requestor, and a non-related person information management system 6000, which extracts information of non-related persons based on the extracted related person information and provides it to the above operating computer 1000; a buyer cloud computing device 7000 communicatively connected to the operating computer 1000 and the buyer terminal 3000, having various data related to the payment settlement, and performing and providing the selection of the non-related persons to perform the payment settlement related acts to the operating computer 1000; and a supplier cloud computing device 8000 communicatively connected to the operating computer 1000 and the supplier terminal 4000, having various data related to the payment settlement, and performing and providing the selection of the non-related persons to perform the payment settlement related acts to the operating computer 1000.

The operating computer 1000, and at least one computer included in the non-related person information management system 6000, may comprise at least one server computer capable of executing a computer program or a web program, having communication means, including at least one hardware processor and memory storing the computer program or the web program.

The data storage device 2000 may comprise a database management system (DBMS).

The buyer terminal 3000, the buyer non-related person terminal 3100, the supplier terminal 4000, and the supplier non-related terminal 4100 may comprise a terminal such as a smartphone, a tablet computer, a personal computer (PC), a laptop, or the like that is equipped with communication means and is capable of executing a computer program or a web program, including at least one hardware processor and a memory for storing the computer program or the web program.

The buyer account information storage device 3200 and the supplier account information storage device 4200 may comprise a financial institution storage device that stores and manages general account information opened and used at a commercial financial institution of the buyer and the supplier.

The buyer edge computing device 3300 and the supplier edge computing device 4300 may comprise devices included in the buyer terminal 3000 and the supplier terminal 4000 where information can be stored, in a distributive manner or may comprise peripheral storage devices used by the buyer or supplier.

The exchange rate information provision computer 5000 may be configured as a public institution computer such as a financial institution that handles foreign exchange or a financial integration organization that handles exchange rate information, and may be configured to provide real-time update information of the exchange rate to the operating computer 1000.

The update information of the exchange rate may be provided to the operating computer 1000 every time the operating computer 1000 connects to a communication or requests it, or at a set interval, or in real time.

The non-related person information management system 6000 may be configured to perform user authentication of the buyer or supplier by the related persons for identity verification of the buyer or supplier, or to extract non-related information of the buyer and supplier that excludes the related persons based on the information of the related persons.

The buyer cloud computing device 7000 and the supplier cloud computing device 8000 may be configured to store information related to payment settlements between the buyer and the supplier that can be managed by the operating computer 1000, and to provide the information to the buyer terminal 3000 and the supplier terminal 4000, and to execute a program to perform the selection of non-related persons.

The operating computer 1000 of the present invention may be described as a configuration of the hardware of the operating computer itself, but in an embodiment of the present invention, it is described as each component using a computer program or a web program stored in a memory executed under the control of a hardware processor of the operating computer as an operation management means.

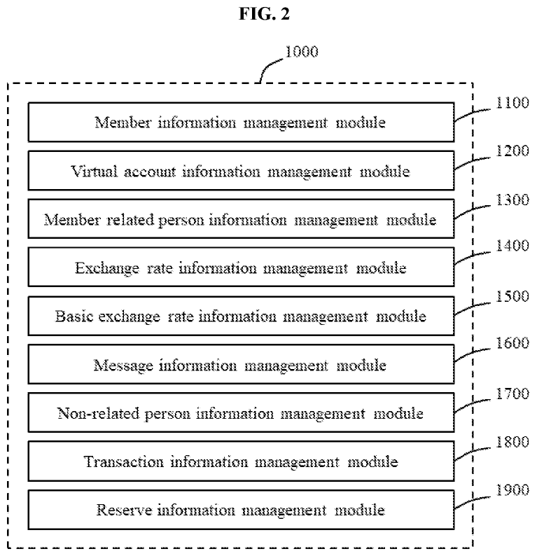

FIG. 2 is a schematic configuration diagram of an embodiment of an operating computer, which is a main part of the payment settlement system of the present invention.

As illustrated in FIG. 2, the operating computer 1000 of the present invention includes a member information management module 1100 that performs and manages user authentication of members based on member information including buyer personal information and buyer terminal information, and supplier personal information and supplier terminal information; a virtual account information management module 1200 that is generated in connection with the account information of the buyer and the supplier generated when the user authentication is performed to perform payment settlement to the buyer and the supplier members; a member related person information management module 1300 that extracts related person information that confirms the identity of the member at the time of membership registration or user authentication of the buyer and supplier members, and extracts and manages non-related person information based on the related person information; an exchange rate information management module 1400, which updates and manages the exchange rate information applied when the buyer and the supplier member want to perform payment settlement for the transaction of goods in real time; a basic exchange rate information management module 1500 that manages updates to the basic exchange rate between the payable asset and the receivable asset when the buyer and the supplier member perform payment settlement for the trade of goods; a message information management module 1600 that manages a message confirming the intention to make a payment settlement and a reply message from the buyer terminal when making a payment settlement for a transaction of goods between a buyer and a supplier member; a non-related person information management module 1700 that manages information of a non-related person not related to the buyer and the supplier member who participates in approving payment settlement for the transaction of goods between the buyer and the supplier member and sends a message to the buyer terminal confirming the intention to make payment; a transaction information management module 1800 that stores and manages information on transactions of goods, payment settlements, etc. between a buyer and a supplier member; and a reserve information management module 1900 that manages profits accrued to non-related person who participate in approving the payment settlement and sending a payment settlement intention confirmation message to the buyer terminal.

The membership information management module 1100 receives the personal information and terminal information entered by the buyer and the supplier using the terminal and performs membership registration, but it can also be done by entering general personal information and setting an ID/password (PW) to register, but the user authentication of the membership requestor can be performed by confirming the identity through the related persons of the membership requestor using the non-related person information management system, and then registering as a member after performing user authentication.

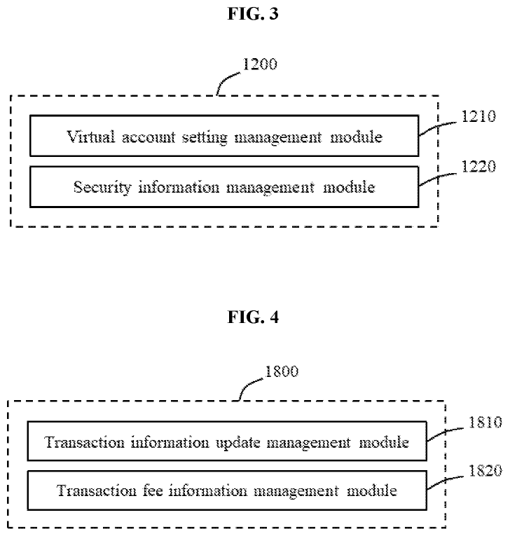

FIG. 3 is a schematic configuration diagram of an embodiment of a virtual account information management module, which is a main part of the operating computer of the present invention.

As illustrated in FIG. 3, the virtual account information management module of the present invention includes a virtual account setting management module 1210, which opens and manages a virtual account based on the setting information of the buyer and the supplier so that the buyer and the supplier members can use the payment settlement system of the present invention when the buyer and the supplier members access the operating computer and perform user authentication to use the payment settlement related services; and a security information management module 1220 for storing the virtual account information opened for the buyer and supplier members in the operating computer and the password set for the virtual account in the corresponding storage means of the cloud computing device or the storage means of the edge computing device assigned to the buyer and supplier in order to enhance the security of the payment settlement system of the present invention.

The virtual accounts of the buyer and supplier members opened by the virtual account setting management module 1210 are described as examples in Table 1 below.

TABLE 1

| | | | asset class | asset class |
|---|---|---|---|---|
| Country | region | unique number | number | description |
| Alphabetic | numeric | mixed | 001 | home |
| or country | (4 digits) | alphabetic/ | | currency |
| code | | numeric | | |
| kor or 152 | 82 85 | abcdefg1234567 | 002 | major currency |
| | | | | (US dollar) |
| | | | 003 | cryptocurrency |
| | | | | (bitcoin) |
| | | | 004 | real assets |
| | | | | (gold gram) |

Therefore, if a domestic member opens a virtual account for a US dollar asset, the virtual account information may be opened as ‘kor 8285 abcdefg1234567 002’ in the example. Buyer and Supplier Members may open one or more Virtual Accounts for each type of asset they trade. In the case of virtual accounts, taxation problems may arise from the authorities, but since the virtual accounts of the present invention are basically opened after user authentication, governments can identify the owner of the virtual account when taxing foreign exchange, assets, etc. and can tax or control the increase and decrease of the amount for a certain period of time by identifying the detailed account of a specific person. Regarding the security enhancement of the payment settlement system through the virtual account of the present invention, a person who wants to make a payment settlement according to an asset transaction is registered in the system, and a virtual account is issued to the user authenticated member and set as a second ID. Here, the real name of the user is defined as the first ID, and the second ID is defined as an additional means of identification. When setting a second ID, set a password for logging into the system. The password can be arbitrarily set by the member as a 4-8 digit number, etc.

In another embodiment, for the convenience of members, if you specify a specific device at login, you can provide a function that automatically recognizes the ID and password and logs in at once when accessing the system. In addition, if you specify a range of countries and regions for enhanced security, you can restrict login outside the specified range or configure it to be logged in after going through an enhanced verification procedure.

In another embodiment, for the convenience of members, if you specify a specific device at login, you can provide a function that automatically recognizes the ID and password and logs in at once when accessing the system. In addition, for enhanced security, if a member specifies a range of countries and regions of use, the member's login can be restricted outside the specified range or configured to be logged in after an enhanced verification process.

The second ID (ID) and password (PW) shall be encrypted and stored separately on the principle of non-disclosure, but for enhanced security, the second ID (ID) may be stored on the operating computer (server) of the system and the password may be stored separately on a virtual cloud computing device or edge computing device assigned to each member. After the member's login is authenticated, the member's display on the system may be configured to use a specific name (pseudonym, etc.) designated by the member to the extent that it does not overlap with other members in order to ensure maximum anonymity.

The second ID (ID) and password (PW) shall be encrypted and stored separately on the principle of non-disclosure, but for enhanced security, the second ID (ID) may be stored on the operating computer (server) of the system and the password may be stored separately on a virtual cloud computing device or edge computing device assigned to each member.

After the user authentication of the member for login is completed, in order to ensure maximum anonymity, the display of the member on the system may be configured to use a specific name (pseudonym, etc.) designated by the member to the extent that it does not overlap with other members.

In an embodiment of the present invention, when a member performs user authentication or performs an important act or operation online, such as asset transaction or payment, it may be configured to log in to the system and perform the act or operation through a push message confirmation procedure with a second ID.

In addition, if the second ID is stolen or a problem occurs, it can be configured to discard the second ID after user authentication and reissue it to start anew.

In an embodiment of the present invention, it is possible to block fraudulent use, illegal transactions, etc. in which a person other than the user is arbitrarily authenticated by stealing the user's ID or transacting or paying for assets through the process of confirming the sending and receiving of push messages through the second ID.

FIG. 4 is a schematic configuration diagram of an embodiment of a transaction information management module, which is a main part of the operating computer of the present invention.

As illustrated in FIG. 4, the transaction information management module 1800 of the present invention comprises a transaction information update management module 1810 for updating and managing transaction information of buyer and supplier members through the payment settlement system of an embodiment of the present invention by the member; and a transaction fee information management module 1820 for setting and updating fee information according to transactions using the payment settlement system of buyer and supplier members, and accumulating transaction fee information accrued by the member. The transaction fee for a payment settlement between a buyer and a supplier member may be configured to apply a fee rate that is lower than a currency exchange fee or a remittance fee of a conventional commercial financial institution.

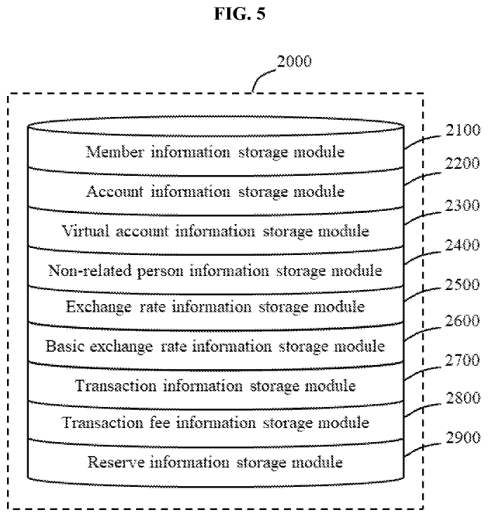

FIG. 5 is a schematic configuration diagram of an embodiment of a data storage device, which is a main part of the payment settlement system of the present invention.

As illustrated in FIG. 5, the data storage device 2000 of the present invention includes a membership information storage module 2100 that stores and manages membership information including buyer personal information and buyer terminal information, supplier personal information and supplier terminal information; an account information storage module 2200 that stores and manages account information opened at a general financial institution for payment and receipt of assets in connection with the virtual account information opened by the buyer and the supplier; a virtual account information management module 2300 that stores and manages virtual account information established by the buyer and the supplier member by entering account setting information after performing user authentication to perform payment settlement; a non-related person information storage module 2400 that stores and manages information a non-related person who is not related to the buyer and the supplier member, such as participating in approving payment settlement for the transaction of goods between the buyer and the supplier member and sending a message to the buyer terminal confirming the intention to make payment; an exchange rate information management module 2500 that stores and manages real-time updated information of the exchange rate to be applied when the buyer and the supplier member wish to perform payment settlement for the transaction of goods; a basic exchange rate information storage module 2600 that stores and manages trade reference rate information and update information of the trade reference rate between the payable asset and the receivable asset when the buyer and the supplier member want to perform payment settlement for the transaction of the goods; a transaction information storage module 2700 that stores and manages information on transactions of goods between buyer and supplier members, payment settlements, etc.; a transaction fee information storage module 2800 that stores and updates transaction fee information related to fees for transactions using the payment settlement system of the buyer and the supplier, and cumulatively stores and manages transaction fee information generated by each member; and a reserve information storage module 2900 that accumulatively stores and manages profits accrued to non-related persons who participated in approving the payment settlement and sending a message confirming the intention to make the payment settlement to the buyer terminal.

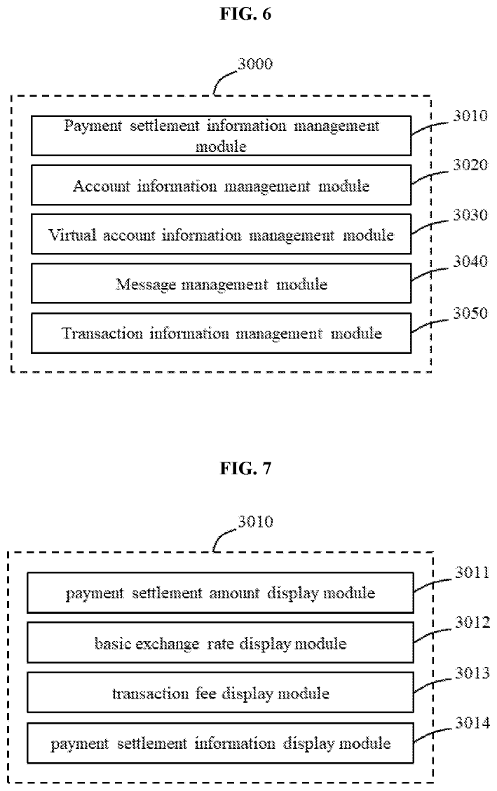

FIG. 6 is a schematic configuration diagram of an embodiment of a buyer's terminal, which is a main part of the payment settlement system of the present invention.

The configuration of the buyer's terminal 3000 in FIG. 6 may be a hardware configuration but is described here as a component of a buyer payment settlement method consisting of a stored computer program or an output web program that is executed using the hardware resources of the buyer terminal. The same applies to various terminals hereinafter.

As illustrated in FIG. 6, the buyer payment settlement means (buyer terminal) 3000 of the present invention includes a payment settlement information management module 3010 that displays purchase information and payment asset amount information for purchasing goods from a supplier member and making payment settlement through a virtual account, and performs and manages payments, etc.; an account information management module 3020 that manages account information opened at a financial institution to which real assets are added or subtracted in connection with the buyer virtual account; a virtual account information management module 3030 that displays at least one virtual account information opened and managed by the operating computer after user authentication of the buyer is performed when the buyer wants to make a payment settlement for a transaction with the supplier after registering as a member of the operating computer; a message management module 3040 capable of displaying a payment settlement confirmation message sent by the operating computer, the buyer cloud computing device, or a non-related person selected by the buyer edge computing device, and transmitting a response message to the payment settlement confirmation message when the buyer member requests the operating computer to pay the transaction price when the buyer member performs a transaction of goods with the supplier member; and a transaction information management module 3050 that is managed to check a list of transaction information and details of transactions made by a buyer member using a buyer terminal using the payment settlement system.

FIG. 7 is a schematic configuration diagram of an embodiment of a payment settlement information management module, which is a main part of the buyer's terminal of the present invention.

As illustrated in FIG. 7, the payment settlement information management module 3010 of the present invention includes a payment settlement amount display module 3011 that displays a transaction amount of a good to be paid to a supplier as an asset to be used by a buyer; a basic exchange rate display module 3012 that displays a transaction rate to be converted from a transaction amount of a good to be paid to a supplier as an asset to be used by a buyer; and a transaction fee display module 3013 that displays transaction fee information to be applied when a buyer and a supplier member make a payment using the payment settlement system based on a transaction of goods; and a payment settlement information display module 3014 that displays payment settlement information for a transaction in which a payment settlement to the supplier is completed.

The basic exchange rate displayed in the basic exchange rate display module 3012 is a globally recognized and authoritative exchange rate between foreign currencies or assets, which can be set based on information queried online in real time.

Table 2 below shows an example of a real-time quoted basic exchange rate between assets.

TABLE 2

| | Trading | | Basic exchange | Basic exchange |
|---|---|---|---|---|
| | instruments | Example | rate | rate(reverse) |
| 1 | Local currency | Korea(KRW) = | 1KRW = 20.904752VND | 1VND = 0.04783601KRW |
| | vs. counterparty | VietNam(VND) | | |
| | currency | | | |
| 2 | Cryptocurrencies | Bitcoin = USD | 1BTC = 16265.20USD | 1USD = 0.000061BTC |
| | vs. Major | | | |
| | Currencies | | | |
| 3 | Various Assets | Gold (grams) = | 1GAU = 67413376KRW | 1KRW = 0.000015GAU |
| | vs. Major | Korea | | |
| | Currencies | (KRW) | | |

FIG. 8 is a schematic configuration diagram of an embodiment of a virtual account information management module, which is a main part of the purchasing terminal of the present invention.

As illustrated in FIG. 8, the virtual account information management module 3030 of the present invention includes a virtual account information display module 3031 that displays at least one virtual account information opened by a buyer member; a security information management module 3032 that is capable of entering a password for the virtual account set to enhance security for the buyer virtual account and performs login management in connection with an operating computer, a buyer cloud computing device, or a buyer edge computing device that manages the password; a virtual account asset information display module 3033 that displays and manages the balance information of the virtual account for each type of asset of the buyer; and a virtual account issuance information management module 3034, which manages the virtual account opening history information of the buyer that is reissued and set by the operating computer in the event of a security problem related to the buyer virtual account.

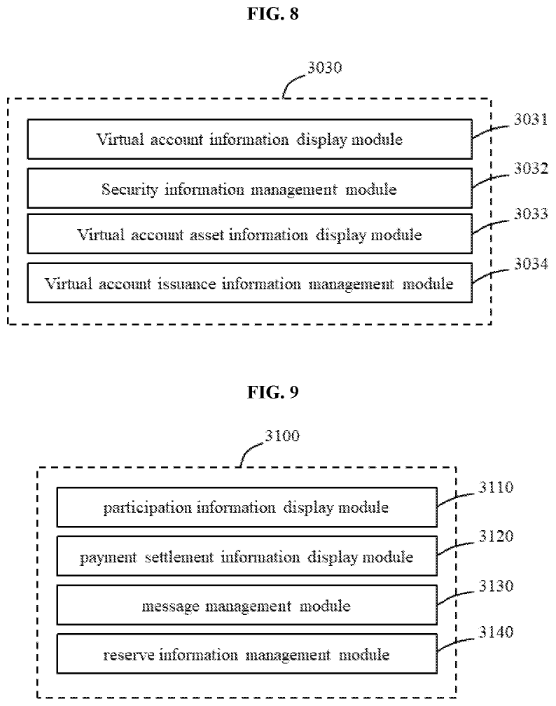

FIG. 9 is a schematic configuration diagram of an embodiment of a buyer non-related person terminal, which is a main part of the payment settlement system of the present invention.

As illustrated in FIG. 9, the buyer non-related person terminal 3100 of the present invention includes a participation information display module 3110 for displaying participation information of the buyer in the transmission of a payment settlement confirmation message and the approval act of payment settlement in connection with the payment settlement, which is an embodiment of the present invention; a payment settlement information display module 3120 that displays the payment settlement information of the buyer provided by the operating computer as data for performing an approval act regarding the payment settlement of the buyer; a message management module 3130 that displays messages to be transmitted to the buyer terminal to confirm the buyer's intention to make the payment settlement and manages the transmission; and a reserve information management module 3140 that displays and manages the use of reserve information that the operating computer accumulates in exchange for participation in approving the buyer's payment settlement and sending the confirmation message.

Although the above description of an embodiment of the present invention centers on a buyer, a supplier terminal, a supplier non-related person terminal, a supplier account information storage device, and a supplier edge computing device also have configurations corresponding to the buyer described above.

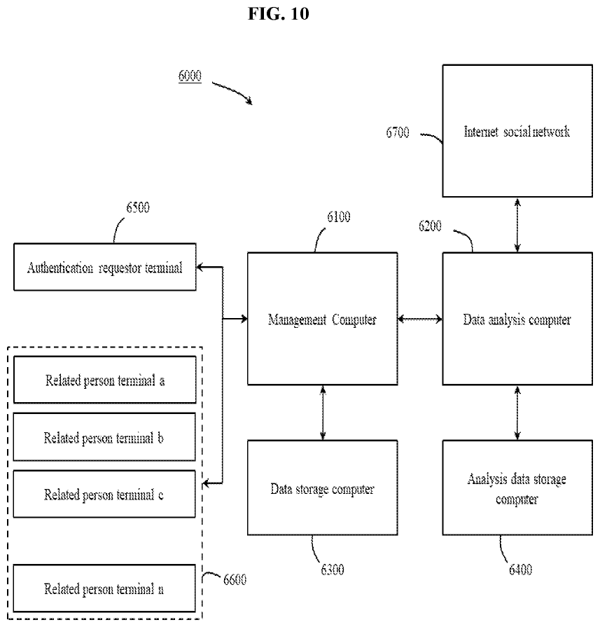

FIG. 10 is a schematic configuration diagram of an embodiment of a non-related person information management system, which is a main part of the payment settlement system of the present invention.

As illustrated in FIG. 10, the non-related information management system 6000 of the present invention includes a management computer 6100 that receives and manages information of surrounding related persons, including acquaintances of the authentication requestor, in response to an authentication request entered by a person who wishes to participate in the payment settlement system of the present invention, manages the generated user authentication information and identity authentication information, and extracts and manages information of non-related persons based on the related person information; a data analysis computer 6200 that receives a request for the identity authentication of the authentication requestor from the management computer 6100, performs the identity authentication of the authentication requestor, and provides it to the management computer 6100; a data storage computer 6300 that stores data including user authentication requestor information, related person group information, communication details information of the related person group, and identity authentication information transmitted from the data analysis computer 6200 managed by the management computer 6100; an analysis data storage computer 6400 that stores and manages relationship data related to specific relationships between persons collected and analyzed by the data analysis computer 6200 and communication details information of the related person group received from the management computer 6100, and statistical information based on the relationship data related to specific relationships between persons analyzed by the data analysis computer 6200; an authentication requestor terminal 6500 used by an authentication requestor (a buyer or a supplier in an embodiment of the present invention) that is in communication with the management computer 6100 and outputs or executes a user interface for requesting authentication and receiving and managing user authentication approval information; at least one related person terminal 6600 that is in communication with the management computer 6100 and that outputs or executes a user interface that allows a relationship, such as an acquaintance, that has a relationship with the user authentication requestor to provide information to the management computer 6100 such as relationship information and communication details with the user authentication requestor; and an Internet social network 6700 that provides the data analysis computer 6200 with data comprising words, vocabulary, or sentences related to a particular relationship between people.

The management computer 6100 may comprise at least one server computer having communication means and including at least one hardware processor and a memory storing computer programs and the like.

The data analysis computer 6200 may comprise at least one server computer having communication means, at least one hardware processor, and a memory storing computer programs related to artificial intelligence (AI).

The data storage computer 6300 and the analysis data storage computer 6400 may comprise a database management system (DBMS).

The authentication requestor terminal 6500 and the related person terminal 6600 may comprise a terminal such as a smartphone, a tablet computer, a personal computer (PC), a laptop, or the like that is equipped with a communication means and on which an application or a web program may be executed. The application or web program on the authentication requestor terminal 6500 may comprise a user interface for requesting authentication approval from the management computer 6100, and the application or web program on the related person terminal 6600 may comprise a user interface for identity verification that provides the management computer 6100 with relationship information and communication details with the authentication requestor.

The Internet social network 6700 may comprise various social network services (SNS) and Internet media.

The non-related person information management system 6000 of the present invention, wherein at least one hardware processor included in the management computer 6100 controls the execution of a computer program stored in the memory, and receiving identity verification data including the identity consent of the authentication requestor from the related persons based on the information of the related persons of the authentication requestor agreed to access or provided by the authentication requestor; analyzing the communication details information between the related persons who have agreed to the identity of the authentication requestor and the authentication requestor, extracting the relationship data of the communication details related to the specific relationship between the persons and transmitting it to the data analysis computer 6200 to request the authentication of the identity of the authentication requestor; performing authentication of the identity of the authentication requestor based on the matching of the relationship data of the communication details transmitted from the management computer 6100 with the relationship data provided by the external media or retained by the management computer 6100 related to the specific relationship between the persons in the data analysis computer 6200, and transmitting the identity authentication information to the management computer 6100; and performing identity authentication of the authentication requestor based on the identity authentication information transmitted from the data analysis computer 6200 by the management computer 6100.

If the communication details information is voice information, it can be analyzed using voice recognition technology, or it can be analyzed using voice matching, voice to text conversion techniques, etc.

The relationship information between the above related persons and the authentication requestor may be, for example, family members, relatives, friends, work colleagues, schoolmates, social members, hobby acquaintances, etc.

In addition, the communication details information of the above-mentioned related persons or groups of related persons includes various forms of communication conducted using mobile phones, including, for example, mobile phone text messages (SMS, MMS, etc.), chat messages in chat application programs running on mobile phones, text communications on social networking services (SNS), e-mail letters, Internet voice calls on mobile phones, etc.

In the embodiment of the present invention, in the case of verifying the identity of a corporation (enterprise) rather than an individual, considering that a corporation is not concerned about leaking personal information and that the method of verifying the identity of a corporation is well established in the existing system, the criteria for verifying the identity of a corporation, for example, utilizing the address of a corporation instead of a photograph, may be set differently or the method of verifying the identity may be applied more relaxed than in the case of an individual.

For example, if the authentication requestor is a corporation (enterprise), the related person group can be set as at least one employee, business partner, and customer, and as an auxiliary measure to prevent unauthorized use, the method of verification through the corporation's bank, verification through the corporate registration number, or verification through the business registration number can be used.

In the embodiment of the non-related person information management system 6000 of the present invention, the function of the data analysis computer 6200 may be performed by the management computer 6100, and the data analysis computer 6200 may be omitted.

It will now be described in more detail for extracting non-related person information to participate in the acts of identity verification and payment settlement upon membership registration of a buyer or supplier in the non-related person information management system 6000.

For the identity authentication of a buyer or supplier in the non-related person information management system 6000 of the present invention, comprising: receiving, by a management computer 6100, authentication requestor information and at least one password from the authentication requestor terminal 6500 of the authentication requestor who wants to verify user authentication and stores the authentication requestor as a member; receiving, by the management computer, the user authentication approval request data transmitted from the authentication requestor terminal, including the name and photo of the authentication requestor, or the name and mobile phone number, and the password, the information of the related persons stored in the communication-capable terminal of the authentication requestor, and the intention to consent to the use of the related persons' information; transmitting, by the management computer, an identity verification request message including authentication requestor information including the authentication requestor's name and photograph, or the authentication requestor's name and mobile phone number to the related person terminal 6600 of the related persons of the authentication requestor; receiving, by the management computer, the information of the related persons transmitted from the related person terminal, including the relationship with the authentication requestor and the communication details with the authentication requestor, and the identity verification data necessary to determine the identity of the authentication requestor; transmitting, by the management computer, the information of the related persons including the communication details with the authentication requestor transmitted from the related person terminal to the data analysis computer 6200, and requesting an identity verification determination; analyzing, by a data analysis computer, the information of the related persons including the communication details of the authentication requestor and the related persons transmitted from the management computer to extract the communication details relationship data related to the establishment of a relationship between people, and analyzing the extracted communication details relationship data and the information such as words and expressions used in daily conversations and conversations between acquaintances in its own possession, and compares it with the big data (self-possessed relationship data) managed by the database, and if the conformity exceeds a certain percentage, generating and transmitting the identity verification information to the management computer; and receiving and storing, by the management computer, the identity verification information of the related persons of the authentication requestor transmitted from the data analysis computer, and transmitting the identity verification approval information to the authentication requestor terminal based on it.

Based on the information of the related persons extracted for the user authentication of the buyer or supplier member in the non-related person information management system 6000, the information of the non-related persons not related to the buyer and supplier can be extracted.

The non-related information management system 6100 may compare the information of the related persons extracted to perform the user authentication of the buyer and supplier members with the information of the members registered in the system of the present invention stored in the membership information storage module, and select the remaining members' information excluding the information of the related persons as non-related of the buyer and supplier, and transmit the extracted non-related information to the operating computer.

Hereinafter, with reference to FIGS. 1 through 10, an example of the operation of an embodiment of the payment settlement system of the present invention will be described.

The embodiment of the present invention is characterized in that even if the assets that the buyer wishes to use (pay) and the assets that the seller (supplier) wishes to receive are different, each of them can directly transact with the desired assets if a mutual basic exchange rate is published.

The operating computer 1000 registers a buyer who wants to make a payment settlement according to an asset transaction as a member of the system, and then issues a virtual account for each asset type based on the information set by the member based on the identity authentication of the related person by the non-related person information management system 6000 or through the verification of general personal information to the user authenticated member, and sets it as the member's second ID. Here, it is possible to define the member's real name as the first ID and the additional member's virtual account as the second ID of the user authentication means.

When setting a second ID, the member can set a password for logging into the system, such as a 4-8 digit number. In addition, for the convenience of members, if a member specifies a specific terminal when logging in, the ID and password can be automatically recognized and logged in at once when accessing the system. In addition, for enhanced security, if the member specifies the country and region of use, the login can be restricted outside the specified range or logged in after an enhanced verification procedure.

The processes of membership registration, virtual account generation, etc. can be applied equally to suppliers as well as buyers.

The second ID and password are encrypted and stored separately on the principle of non-disclosure, but for enhanced security, the second ID is stored on the operating computer (server) 1000 of the system and the password is stored separately on the virtual cloud computing device 7000 and 8000 or edge computing device 3300 and 4300 assigned to each member.

In addition, when a member logs in, the membership display on the system can be configured to allow the member to use a specific name (pseudonym, etc.) specified by the member to the extent that it does not overlap with other members, thereby ensuring maximum anonymity after user authentication.

When a member accesses and logs in to the operating computer 1000 of the present invention to perform user authentication or to perform important acts or operations online, such as asset transactions and payment settlement, the acts or operations can be performed through the confirmation process of the push message received by the member's second ID.

In the embodiment of the present invention, through the confirmation process of sending and receiving push messages through the member's second ID, it is possible to efficiently block fraudulent use or illegal transactions such as arbitrary authentication, asset transactions, or payments by a person other than the user by stealing the user's ID.

In addition, in the event that a member's second ID is stolen or a problem occurs, it may be configured to discard the user authentication and the existing second ID and reissue it to the operating computer 1000 to start anew.

In addition, an embodiment of the present invention is configured to complete the payment settlement by applying the basic exchange rate at the time the buyer requests the payment settlement and approving the payment settlement by non-related persons who are not related to the buyer and the supplier.

As described above, one of the features of the payment settlement system of the present invention is that a message confirming the intention of the buyer to make a payment settlement is sent and confirmed by a non-related person, and the non-related person participates in the approval of the buyer's payment settlement.

The payment settlement system of the present invention may be configured to complete the payment settlement between the buyer and the supplier member by providing the transaction information between the buyer and the supplier member and the payment settlement information of the buyer member to the non-related person terminal 3100 of a selected plurality of non-related persons who are not related to the transaction party or a selected plurality of non-related persons of the transaction party selected by the data analysis computer 6200, so that the payment settlement between the transaction party is completed by receiving information from the selected plurality of non-related persons whether the payment settlement of the buyer member is approved or not.

The payment settlement-related application or web program executed or output from the non-related terminal 3100 is configured to provide the operating computer 1000 with the approval information of the payment settlement of the buyer member and to check the profit information of the payment settlement-related participation provided by the operating computer 1000.

Furthermore, the non-related person terminal 3100 may include means for storing and managing a transaction lodger provided by the operating computer 1000, which has completed a payment settlement of the buyer member based on the payment settlement approval data provided by the non-related person terminal 3100 and has generated a transaction lodger for the payment settlement.

In an embodiment of the present invention, the extraction of non-related person information is performed by the data analysis computer 6200 connected to the management computer 6100 of the non-related person information management system 6000, which selects a plurality of non-related person information, including non-related person terminal information, from the member information stored in the data storage computer 6300 that has no relation to the buyer or supplier member by a set rule or randomly, and provides it to the operating computer 1000.

The operating computer 1000 requests confirmation of the payment details of the buyer to the buyer non-related person terminal 3100 of the non-related person of the buyers, and completes the payment settlement of the buyer member based on the payment settlement details approval information provided by the multiple buyer non-related person terminals 3100.

Furthermore, the operating computer 1000 generates a transaction ledger including the completed payment settlement information of the buyer member and stores it in the data storage device 2000 in connection with the buyer member information, and stores, in a distributive manner the transaction ledger to the buyer terminal 3200, the supplier terminal 4000 that is a party to the transaction, or the storage space of the cloud computing device granted to the buyer and the supplier, or the storage space of the edge computing device of the buyer and the supplier, and the multiple buyer non-related person terminals 3100 that participated in approving the payment settlement.

In an embodiment of the payment settlement system of the present invention, the benefit provided to the non-related persons providing the payment settlement approval information may be that the reserve information management module 1900 of the operating computer 1000 provides a predetermined number of points (e.g., 1 point for each payment settlement approval) to the non-related persons as compensation for approving the payment settlement by the non-related persons and storing the generated transaction ledger in the reserve information storage module 2900.

Considering that the non-related persons for the payment settlement approval are randomly selected by the operation computer 1000 or the data analysis computer 6200, it has the effect of providing a predetermined number of points to all members using the payment system of the present invention in an unbiased manner. The points can be set to be used like cash in the payment settlement system of the present invention.

As described above, in an embodiment of the payment system of the present invention, when the payment settlement details information of the buyer member (such as the calculation details between the parties of payment settlement) and the payment settlement approval information of the non-related persons are received by the operating computer 1000, the operating computer 1000 checks whether the calculation details of the payment settlement parties and the payment settlement approval details of the non-related persons match in the transaction ledger. When the operating computer 1000 or the data analysis computer 6200 finally checks whether the payment details calculated by the operating computer 1000 or the data analysis computer 6200 match the payment details and the transaction ledger, if they match, the payment settlement is finally authorized, and the transaction ledger of the completed payment details is generated and stored, in a distributive manner to each block (such as the buyer terminal, the supplier terminal, the non-related person terminal, and the operating computer).

In the following, the reasons for involving the non-related persons in approving the payment settlement of the buyer member in the payment settlement system of the present invention and the meaning of approving the payment settlement of the non-related persons will be further explained.

The payment settlement in the embodiment of the payment settlement system of the present invention is made based on the virtual accounts of the buyer member and the supplier member. When the payment settlement system of the present invention is operated, the account information of the virtual accounts of certain transaction parties (buyer and supplier) starts from 0 (zero), and if it is linked to account information of existing banks, transactions may be carried out with a certain balance. A payment settlement is nothing more than an expression of intent to authorize the transfer of monetary value equivalent to the goods from the buyer's account or accounts to the supplier's account or accounts in payment settlement for the goods provided by the supplier, and the approval of such payment settlement may be a simple calculation.

For example, if buyer A purchases a watch from supplier B for KRW1,000,000, the payment can be described as a debit of KRW1,000,000 to account A and a credit of KRW1,000,000 to account B, resulting in a debit of KRW1,000,000 to the balance of account A and a credit of KRW1,000,000 to the balance of account B. Therefore, anyone with a terminal equipped with an application or program that performs arithmetic operations can calculate and approve payment settlement details anywhere.

However, if the simple calculation is left to a specific person, it will be falsified, so the reliability of the payment settlement details can be secured by sharing the payment settlement details with the operating computer and non-related of the transaction parties to prevent falsification. This is because non-related person have no incentive to provide more or less financial information about the payment settlement of a person they do not know, so the authorization of the payment settlement by non-related persons can ensure its reliability. Also, the payment settlement system of the present invention can be configured to automatically calculate and approve the payment settlement by a calculator application program instead of manually calculating and approving the payment settlement by a non-related person, so that the burden on the non-related person in approving the payment settlement is minimized.

The non-related person in the embodiment of the present invention may be configured to be selected randomly, excluding the acquaintances of the transaction party and excluding all related persons who have communication details, transaction relationship, and interest with the transaction party. If the transaction parties (buyer and supplier) have different nationalities, the non-related person may be configured to select a member whose nationality is different from that of the transaction parties.

Furthermore, in cases where the transaction parties (buyer and supplier) are of different nationalities, the selection of non-related persons preferably includes members of different nationalities than the buyer and supplier.

In an embodiment of the present invention, an example is described below in which a buyer and a supplier make payments settlement for a transaction of goods with different types of assets. The basic exchange rate is based on Table 2 above.

If A purchases KRW 1,000 worth of cinnamon from B's Vietnamese shopping mall and pays KRW 1,000, and B wants to receive the payment in Vietnamese dong, the operating computer of the embodiment of the present invention deducts KRW 1,000 from A's KRW virtual account and adds VND 20,904.752 to B's dong virtual account to complete the payment settlement for the transaction between A and B. The payment settlement is completed.

Furthermore, if A purchases a bag worth 1 BTC in B's US shopping mall and pays with Bitcoin, and B wishes to receive the payment in US dollars, the operating computer of the embodiment of the present invention deducts 1 BTC from A's Bitcoin virtual account and adds USD16,265.20 to B's US dollar virtual account, thereby completing the payment settlement according to the transaction between A and B. The payment settlement is completed.

In addition, if A purchases 1 gold gram of goods from B's gold shopping mall and pays in Korean won (KRW), and B wants to receive the payment in Korean won (KRW), the operating computer of the embodiment of the present invention completes the payment settlement according to the transaction between A and B by deducting KRW 67,413,376 from A's Korean won virtual account and adding KRW 67,413,376 to B's Korean won virtual account.

In addition, if there is a separate virtual asset that is converted or linked to the value of a real asset (in the case of Goldgram, a virtual asset can be created using GAU units), the payment can be completed directly in the separate virtual asset. In other words, if A, a German, purchases a shirt (KRW 67,413,376) at a shopping mall in B, a Korean, with his Goldgram crypto, 1 GAU is deducted from A's Goldgram account balance and KRW 67,413,376 is added to B's Korean won virtual account, completing the payment settlement for the transaction.

On the other hand, in transactions such as international trade, there may be cases where there is a difference between the time of payment settlement by the buyer and the time of supply of goods by the supplier, or it is difficult to process at the same time, and in such cases, the escrow function can be added to the system or operating computer of the present invention to resolve the risk burden of the transaction parties. In other words, the buyer deposits part or all of the price of the goods as the transaction amount in the escrow account of the system or operating computer at the same time as the purchase (order for the goods), and only when the supplier sends the goods and the delivery process is underway or the buyer receives the purchased goods, can part or all of the transaction amount in the escrow account be transferred to the supplier to safely complete the transaction of the goods.

In addition, a credit function can be added to the payment settlement for purchasing goods and configured to settle the payment after a certain time after purchase. The credit function can be performed in partnership with a related company such as a credit card company, or the system or operating computer of the present invention can perform the function directly. The system or operating computer can add the credit function by receiving the past transaction details, payment information, delinquency information, etc. of the buyer, extracting the credit rating of the buyer from the big data analyzing the transaction details, payment information, and delinquency information of a similar comparison group, or evaluating the creditworthiness and granting credit to the buyer. When the credit function is added, the buyer completes payment settlement through the system or operating computer at the time of ordering, and the supplier is guaranteed to receive payment from the system or operating computer, and the final settlement is completed by post-settlement of the payment amount between the buyer and the system or operating computer after a certain time after the purchase.

In the payment settlement system of the present invention, when an asset is withdrawn from a member's virtual account or a payment is made, a push message is sent to the member's virtual account, and only when the member confirms the push message, the withdrawal and payment are executed, thereby preventing payment-related accidents.

Here, the subject of sending the push message is not the operating computer or the counterparty of the present invention, but a predetermined number of non-related persons who are not related to the buyer A and the supplier B (e.g., 2 randomly selected), and the predetermined number of non-related persons send messages to the virtual account of A. If there are multiple senders, the push message is received by A if the messages sent are matched (the scheduled payment amount of the push message is the same without error). In addition, since the push message may be stolen or hijacked by hacking into the system of the present invention or the supplier side, it may be configured to send a message to a non-related person who approves the transaction rather than the operating computer or the supplier side. On the other hand, in order to prevent hacking or other manipulation of the non-related person selection work, the non-related person is not selected by the operating computer of the present invention, but can be configured to proceed with the non-related person selection work on a distributed platform in a virtual cloud computing or edge computing method given to the members.

According to the present invention, payment settlements can be made directly between members anytime and anywhere by minimizing fees (transfer fees, currency conversion fees, intermediary bank fees, SWIFT fees, etc.) and eliminating or reducing the waiting time to complete payment settlements, in order to reduce the large fees paid to intermediaries in other existing asset-to-asset transactions.

The payment settlement system including the operating computer of the present invention is characterized in that, in connection with the payment process, if the payout assets of the buyer virtual account and the receipt assets of the supplier virtual account are of different types, the buyer's payout assets are directly paid into the buyer's payout assets without exchanging them for other assets, and the supplier's payout assets are directly received into the supplier's receipt assets without exchanging them for other assets. In other words, the payment settlement system of the present invention directly pays the assets held by the buyer without going through intermediary procedures such as currency exchange in transactions between assets of different types, and the supplier can directly receive the assets paid by the buyer into the assets of the type that the supplier has or wants to receive by applying the basic exchange rate to the assets that the supplier wants to receive.

Furthermore, the payment process of the payment settlement system of the present invention is characterized in that the payment settlement is completed without going through any other intermediary or intermediary institution. This means that, except for the participation of non-related persons to the transaction in approving the payment settlement or sending a message to the buyer terminal confirming the intention to make the payment settlement, the payment process can be completed by the process inside the payment settlement system of the present invention without the help of a third party or a third organization outside the system.

Therefore, the system of the present invention has the advantage that various fees such as remittance fees, currency exchange fees, intermediary bank fees, SWIFT fees (wire fees), etc. are not incurred or settlement fees are minimized because no third parties or companies including intermediaries required for transactions between different assets are involved. In the above description of payment systems, considering that the concept of a payment settlement is an indication that the buyer authorizes the transfer of a certain monetary value to the supplier, the same principle can be applied to remittances. If the sender and the recipient want to send or receive different types of assets, the sender can be considered as the buyer of the payment settlement system and the recipient as the supplier of the payment settlement system, or the same can be applied. Thus, in the case of remittances, even if the sender and recipient hold different types of assets, each will be able to send or receive in the asset they hold or want.

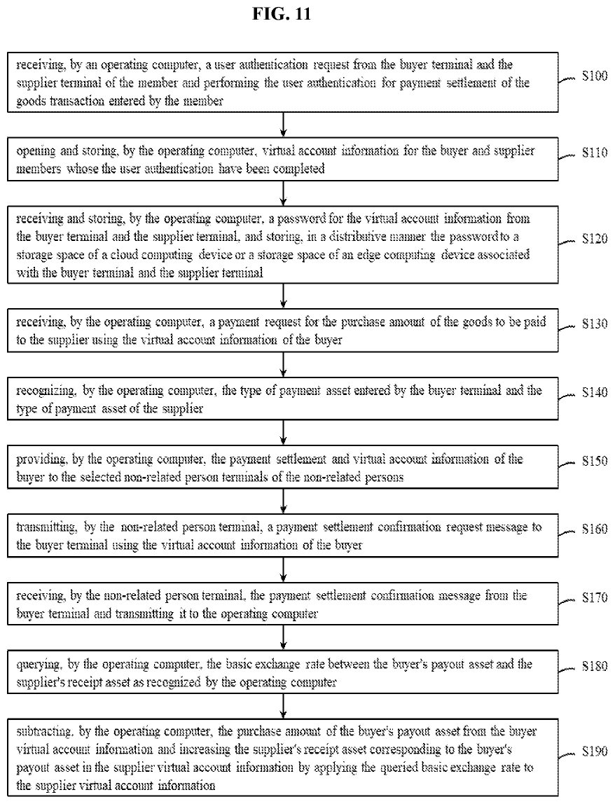

FIG. 11 is a flow chart to illustrate an embodiment of the payment settlement method of the present invention.

As illustrated in FIG. 11, the payment settlement method of the present invention, comprising: receiving, by an operating computer, a user authentication request from the buyer terminal and the supplier terminal of the member and performing the user authentication for payment settlement of the goods transaction entered by the member (S100); opening and storing, by the operating computer, virtual account information for the buyer and supplier members whose the user authentication have been completed (S110); receiving and storing, by the operating computer, a password for the virtual account information from the buyer terminal and the supplier terminal, and storing, in a distributive manner the password to a storage space of a cloud computing device or a storage space of an edge computing device associated with the buyer terminal and the supplier terminal (S120); receiving, by the operating computer, a payment request for the purchase amount of the goods to be paid to the supplier using the virtual account information of the buyer (S130); recognizing, by the operating computer, the type of payment asset entered by the buyer terminal and the type of payment asset of the supplier (S140); providing, by the operating computer, the payment settlement and virtual account information of the buyer to the selected non-related person terminals of the non-related persons (S150); transmitting, by the non-related person terminal, a payment settlement confirmation request message to the buyer terminal using the virtual account information of the buyer (S160); receiving, by the non-related person terminal, the payment settlement confirmation message from the buyer terminal and transmitting it to the operating computer (S170); querying, by the operating computer, the basic exchange rate between the buyer's payout asset and the supplier's receipt asset as recognized by the operating computer (S180); and subtracting, by the operating computer, the purchase amount of the buyer's payout asset from the buyer virtual account information and increasing the supplier's receipt asset corresponding to the buyer's payout asset in the supplier virtual account information by applying the queried basic exchange rate to the supplier virtual account information (S190).

The performing of user authentication (S100) by the operating computer includes a case of performing user authentication for registering membership by a buyer or a supplier who wants to use the payment settlement system of the present invention and a case of performing user authentication for performing a payment settlement by a registered buyer member or supplier member.

User authentication can be performed with the personal information of the authentication requestor, which is commonly done online, or by entering an ID password registered in the system, or through authentication of a phone number. In addition, the user authentication can be performed by verifying the identity of the authentication requestor's related person using the non-related information management system 6000 of the present invention.

In the opening (S110) of the virtual account of the member whose user authentication has been completed by the operating computer, the purchaser member, for example, enters the virtual account generation elements set in the virtual account information management module 3030 of the buyer terminal 3000, such as a country code, an area code, unique identification code (number), and asset type to the operating computer, the operating computer generates and stores a virtual account including the elements set by the buyer member in the virtual account information management module 3030, and allows the buyer terminal to check the opened virtual account information.

When the buyer member requests the operating computer to make a payment for a transaction of goods, the operating computer selects a predetermined number of unrelated parties from the buyer cloud computing device or the edge computing device among the stored unrelated parties of the buyer member, and the unrelated party terminal of the selected unrelated party sends a message (push message) to the buyer terminal confirming the intention to make a payment for the transaction, and receives a confirmation message from the buyer terminal and sends it to the operating computer. The operating computer transmits the virtual account information of the buyer and the payment information to the unrelated terminals of at least one unrelated person of the buyer to request authorization of the payment by the buyer. If the at least one unrelated party determines that there is no error in the transaction history and payment information using the virtual account of the buyer, the buyer's payment authorization information is transmitted to the operating computer. Based on the payment authorization information transmitted from the terminal of the at least one unrelated party, the operating computer decreases the asset of the type to be paid in the virtual account of the buyer by the payment amount, and increases the asset of the type to be received in the virtual account of the supplier by the amount applied to the sales reference rate, thereby completing the payment arrangement according to the transaction of goods between the buyer and the supplier.

The payment process of the operating computer of the payment settlement system of the present invention is carried out in such a way that, if the payment asset of the virtual account of the buyer and the receipt asset of the virtual account of the supplier are of different types, the payment can be made directly with the payment asset of the buyer without exchanging the payment asset of the buyer for the other asset; or wherein the payment asset of the buyer virtual account and the receiving asset of the supplier virtual account are of different types, the payment is carried out in such a way that the buyer's payout asset can be directly received by the supplier's receipt asset without exchanging it for another asset, and in particular, the payment is completed without going through any other intermediary or intermediary institution.

The above-described embodiments of the invention are only some of the various embodiments of the present invention. Without limiting the country and territory of the invention, it is natural that various embodiments of the invention fall within the scope of protection of the invention, including the technical idea that an operating computer mediates payment settlement in real time by applying a virtual account opened for each type of asset and a published basic exchange rate, even if the type of asset to be paid by the buyer and the type of asset to be received by the supplier are different, and the technical idea that the approval of the payment settlement by the buyer is carried out with the participation of non-related persons who are not related to the buyer member or the supplier member.

### INDUSTRIAL APPLICABILITY

The present invention can be used in industries where payment settlements can be made in real time between transaction parties online.

What is claimed is:

1. An operating computer for managing payment settlement, comprising:
at least one hardware processor, and a memory storing a payment settlement-related computer program or web program,
wherein the at least one hardware processor controls the execution of the computer program or web program stored in the memory to:
receive information of a request for payment settlement of a transaction amount via a virtual account of a buyer and a virtual account of a supplier;
receive payment settlement approval information provided by a non-related person terminal used by at least one non-related person unrelated to the buyer and the supplier extracted from the communication details of the buyer and the supplier; and
process the transfer of the transaction amount from the buyer virtual account to the supplier virtual account based on the payment settlement approval information of the non-related person.

2. The operating computer of claim 1, wherein the at least one non-related person is extracted by excluding at least one related person selected through analysis of the respective communication details of the buyer and the supplier.

3. The operating computer of claim 1, wherein the non-related person terminal transmits payment settlement confirmation request message to the buyer terminal to confirm the buyer's intention to pay.

4. The operating computer of claim 1, wherein the payment settlement information of the transactions amount is distributed and stored in conjunction with the information of buyers, suppliers, and non-related persons.

5. The operating computer of claim 1, wherein the transfer of the transaction amount from the buyer virtual account to the supplier virtual account verifies the information of the assets used by the buyer virtual account and the supplier virtual account, and
if the types of assets used by the buyer virtual account and the supplier virtual account are different, the transaction amount calculated by applying the basic exchange rate for each asset is transferred from the buyer virtual account to the supplier virtual account.

6. The operating computer of claim 1, wherein the virtual accounts of the buyer and supplier include identifying information indicating the type of transaction asset entered from the buyer terminal or supplier terminal.

7. The operating computer of claim 1, wherein if the payout assets of the buyer virtual account and the receipt assets of the supplier virtual account are of different types, the payout assets of the buyer virtual account will be paid in the payout assets of the buyer virtual account without exchanging them for other assets.

8. The operating computer of claim 1, wherein if the payout assets of the buyer virtual account and the receipt assets of the supplier virtual account are of different types, the buyer's payout assets are accepted as the supplier's receipt assets without exchanging them for other assets.

9. The operating computer of claim 1, wherein the payment process of the operating computer is completed the payment settlement without going through any other intermediary or intermediary organization.

10. A payment settlement method for a transaction between a buyer and a supplier, comprising:
receiving, by an operating computer, a payment settlement request information of the transaction amount through the buyer virtual account and the supplier virtual account;
receiving, by the operating computer, payment settlement approval information provided by a non-related person terminal used by at least one non-related person unrelated to the buyer and the supplier extracted from the communication details of the buyer and the supplier; and
performing, by the operating computer, transfer processing of the transaction amount from the buyer virtual account to the supplier virtual account based on the payment settlement approval information of the non-related person.

11. The payment settlement method of claim 10, wherein the at least one non-related person is a person who extracts the information of a related person, including an acquaintance, analyzed through the communication details of the buyer and the supplier, and excludes the extracted related person.

12. The payment settlement method of claim 11, wherein the information of the non-related person who participates in payment settlement approval among the information of at least one extracted non-related person is randomly selected.

13. The payment settlement method of claim 10, wherein the processing the transfer of the transaction amount from buyer virtual account to the supplier virtual account is to verify the information of the assets used by the buyer virtual account and the supplier virtual account, and if the types of assets used are different, to transfer the transaction amount calculated by applying the basic exchange rate for each asset from the buyer virtual account to the supplier virtual account.

14. A system for payment settlement comprising an operating computer including computer hardware that causes the system to perform:
receiving a payment settlement request for the transaction amount of goods from the supplier using the buyer virtual account;
extracting the related person information of the buyer and the supplier by analyzing the communication details of the buyer and the supplier, and selecting non-related persons of the buyer and the supplier, excluding the extracted related person information, as authentication participants for the buyer's payment request;
receiving a payment settlement approval information for the transaction amount of the buyer through the non-related person terminal of the selected non-related person;
querying the basic exchange rate information to be applied if the type of payout asset in the buyer virtual account is different from the type of receipt asset in the supplier virtual account; and
subtracting the payout asset of the transaction amount from the buyer virtual account, and increasing the receipt asset of the transaction amount by applying the basic exchange rate queried in the supplier virtual account.

15. The system for payment settlement of claim 14, wherein the virtual account information is stored in the system, and the password set by opener of the virtual account creator is stored, in a distributive manner in the storage space of the cloud computing device or the edge computing device associated with opener of the virtual account.

16. A payment settlement method using a system including an operating computer managing for payment settlement for the transaction of buyer and supplier, comprising:
receiving, by the operating computer, a payment settlement request for the transaction amount of goods from the supplier using the buyer virtual account;
extracting, by the operating computer, the related person information of the buyer and the supplier by analyzing the communication details of the buyer and the supplier, and selecting non-related persons of the buyer and the supplier, excluding the extracted related person information, as authentication participants for the buyer's payment request;
receiving, by the operating computer, a payment settlement approval information for the transaction amount of the buyer through the non-related person terminal of the selected non-related person;
querying, by the operating computer, the basic exchange rate information to be applied if the type of payout asset in the buyer virtual account is different from the type of receipt asset in the supplier virtual account; and
subtracting, by the operating computer, the payout asset of the transaction amount from the buyer virtual account, and increasing the receipt asset of the transaction amount by applying the basic exchange rate queried in the supplier virtual account.
